(19) United States
(12) Patent Application Publication
(10) Pub. No.: US 2009/0237423 A1
(43) Pub. Date: Sep. 24, 2009

(54) Display apparatus of adjusting gamma and brightness based on ambient light and its display adjustment method

(75) Inventors: Cheng-Chung Shih, Fremont, CA (US); Koon Wing Tsang, Fremont, CA (US)

Correspondence Address: BACON & THOMAS, PLLC, 625 SLATERS LANE, FOURTH FLOOR, ALEXANDRIA, VA, 22314-1176, US

(73) Assignee: CAPELLA MICROSYSTEMS, Corp.

(21) Appl. No.: 12/076,572

(22) Filed: Mar. 20, 2008

(51) Int. Cl. G09G 5/10; G09G 3/36

(52) U.S. Cl. 345/690; 345/102

(57) ABSTRACT

This invention discloses a display apparatus capable of adjusting gamma and brightness based on ambient light and its display adjustment method. The display apparatus is adjusted to display an image output signal based on an image input signal and the correlated color temperature and brightness of an ambient light. The display apparatus includes a plurality of light sensing circuits, a memory unit, an image processing module, and a display module. The light sensing circuit senses the ambient light to produce a digital ambient color temperature index value. The memory unit stores a lookup table of brightness expression rates and gamma adjustment parameters corresponding to different color temperature index values. The image processing module produces a gamma adjustment parameter by a lookup table based on the color temperature index value and generates the gamma expression rate of the image input signal. The image processing module adjusts the image input signal to generate the image output signal based on the gamma adjustment parameter. The display module displays the image output signal.

### BACKGROUND OF THE INVENTION

1. Field of the Invention

The present invention relates to a display apparatus of adjusting gamma and brightness and its display adjustment method, and more particularly to a display apparatus that employs an ambient light sensor having color and brightness detection functions and gamma and brightness adjustment method thereof.

2. Description of the Related Art

Referring to FIG. 1 for a schematic diagram illustrates a conventional display apparatus capable of adjusting a backlight brightness, the display apparatus 100 includes a light sensing circuit 110, an analog-to-digital converter 115, an image processing module 120, a digital-to-analog converter 125, a memory unit 130, a backlight module 140 and a display module 145.

The light sensing circuit 110 is provided for sensing an ambient light level to generate an ambient light signal SA, and the analog-to-digital converter 115 converts the analog ambient light signal SA into a digital ambient light signal SDA. The memory unit 130 is provided for storing a lookup table 135, and the lookup table 135 provides a plurality of brightness expression rates and a plurality of backlight adjustment parameters corresponding to different digital ambient light signals SDA. The image processing module 120 receives the digital ambient light signal SDA and an image input signal 101, and the image processing module 120 has an image format conversion function for converting the image input signal 101 into an image output signal 102, and the image output signal 102 can be displayed on a display module 145. The image processing module 120 also has a backlight brightness control function, and the lookup table 135 stored in the memory unit 130 provides a digital backlight adjustment parameter based on the digital ambient light signal SDA and the brightness expression rate required by the desired displaying screen, and the digital-to-analog converter 125 converts a digital backlight adjustment parameter into an analog backlight adjustment parameter, and the backlight module 140 adjusts the backlight brightness based on the analog backlight adjustment parameter. In the aforementioned conventional display apparatus, the backlight module 140 can only adjust the backlight brightness based on the brightness of the ambient light.

However, the foregoing conventional display apparatus just provides an automatic adjustment mechanism for backlight brightness, but not an automatic adjustment mechanism for gamma and brightness or backlight color temperature contrast. Since the ambient color temperature tends to be a warm color in an illumination environment of incandescent light bulbs, therefore the displayed color should be adjusted to a cold color or higher color temperature value to enhance the image contrast between the environment and the displaying screen. In some applications like the web camera, the gamma correction factors and the white balance point of the image is corrected based on the ambient light color temperature information. For example, in an illumination environment of fluorescent light bulbs or in a dark rainy environment, the ambient light color temperature tends to be a cold color, and thus the gamma correction factors of red, green and blue color space (R, G, B) should be adjusted to a warmer color to improve the image contrast between the environment and the displaying screen. Further, the screen display should be adjusted to high color temperature contrast and high brightness for an outdoor environment in order to achieve a vivid image viewing level. In other words, the conventional display apparatus cannot adjust both gamma and brightness automatically based on different ambient lighting environments. In view of the foregoing shortcomings of the prior art, the proposed color display system is to provide a display apparatus with an ambient light sensor having color and brightness detection functions and its display adjustment method, thereby overcoming the shortcomings of the prior art.

### SUMMARY OF THE INVENTION

It is a primary objective of the present invention to provide a display apparatus with an ambient light sensor having color and brightness detection functions and its display adjustment method for adjusting gamma and brightness. A gamma expression rate and a brightness contrast expression rate of an input image are generated to provide an output image with enhanced the color contrast.

To achieve the foregoing objective, the present invention provides a display apparatus for receiving and displaying an image input signal, and the display apparatus comprises a red light sensing circuit, a green light sensing circuit, a blue light sensing circuit, a memory unit, an image processing module, and a display module.

The red light sensing circuit is provided for sensing a red light brightness of the ambient light to generate a red light brightness signal, and the green light sensing circuit is provided for sensing a green light brightness of the ambient light to generate a green light brightness signal, and the blue light sensing circuit is provided for sensing a blue light brightness of the ambient light to generate a blue light brightness signal. The memory unit is provided for storing a lookup table, and the lookup table provides a plurality of gamma coefficient and a plurality of gamma adjustment parameters corresponding to different ambient light correlated color temperature conditions. The change of the RGB gamma affects the input image and enhances the image contrast of the display and the ambient light condition. The image processing module is provided for receiving an image input signal from the any image sources such as a web camera, a TV, a digital camera or a digital picture frame, and coupled to the red light sensing circuit, the green light sensing circuit and the blue light sensing circuit so as to receive the red light brightness signal, the green light brightness signal and the blue light brightness signal respectively. The image processing module executes a numeric operation of the red light brightness signal, the green light brightness signal and the blue light brightness signal to generate an ambient color temperature index value (CCT_{ambient}). The image processing module is further coupled to the memory unit and uses the lookup tables to process the image input signal. The image processing module obtains the gamma adjustment parameters from the lookup table based on the ambient color temperature index (CCT_{ambient}) value and generate the gamma correction expression rate of the image input signal. The image processing module adjusts the gamma correction expression rate of the image input signal based on the gamma adjustment parameters to generate the image output signal. The display module is coupled to the image processing module to display the image output signal.

The present invention further provides a gamma and brightness adjustment method for adjusting a display apparatus to display an image output signal based on an image input signal and correlated color temperature and brightness value of an ambient light, and the gamma and brightness adjustment method comprises: setting a lookup table to provide a lookup table of a plurality of gamma correction adjustment parameters corresponding to different ambient color temperature index value (CCT_{ambient}) values, sensing an ambient light correlated color temperature value, executing a signal analysis of the image input signal based on gamma correction adjustment parameters from the lookup table, and using the gamma correction adjustment parameters to adjust the gamma correction expression rate of the image input signal to generate the image output signal.

### BRIEF DESCRIPTION OF THE DRAWINGS

FIG. 1 shows a conventional display apparatus capable of adjusting backlight brightness;

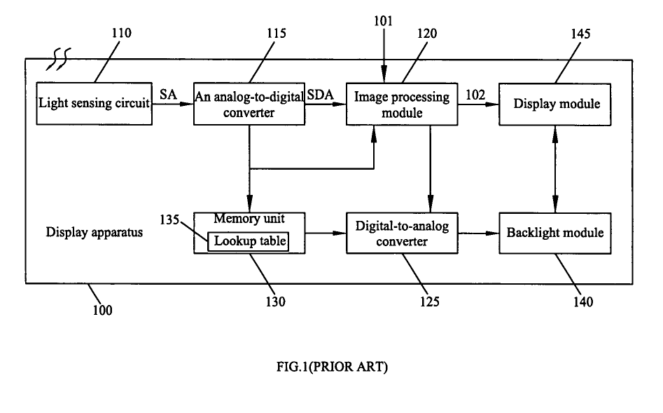

FIG. 2 is a schematic block diagram of a display apparatus having a color and brightness detection function in accordance with a first preferred embodiment of the present invention;

FIG. 3 is a schematic block diagram of a display apparatus having a color and brightness detection function in accordance with a second preferred embodiment of the present invention;

FIG. 4 is a schematic block diagram of a display apparatus having a color and brightness detection functions in accordance with a third preferred embodiment of the present invention; and

FIG. 5 is a flow chart of a gamma correction and brightness adjustment method applied to a display apparatus in accordance with the present invention.

### DETAILED DESCRIPTION OF THE PREFERRED EMBODIMENTS

To make it easier for our examiner to understand the technical characteristics and performance of the present invention, we use preferred embodiments together with the attached drawings for the detailed description of the invention. However, these preferred embodiments are provided for the illustration of the present invention only, and not intended to limit the scope of the invention.

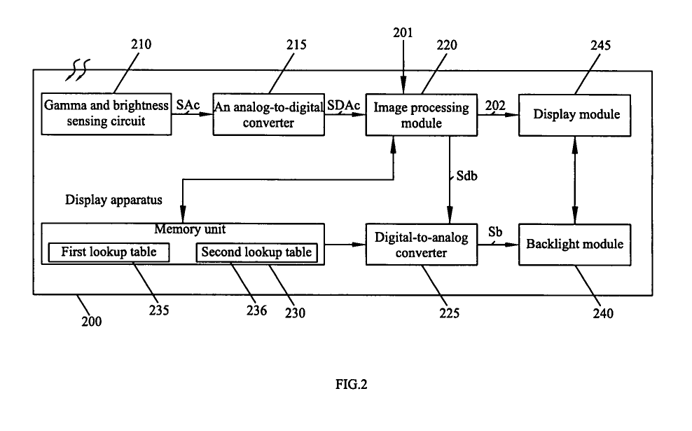

Referring to FIG. 2 for a schematic block diagram of a display apparatus having color and brightness detection functions in accordance with a first embodiment of the present invention, the display apparatus 200 comprises a color and brightness sensing circuit 210, an analog-to-digital converter 215, an image processing module 220, a digital-to-analog converter 225, a memory unit 230, a backlight module 240 and a display module 245.

The color and brightness sensing circuit 210 is provided for sensing the color and brightness of an ambient light to produce an ambient color and brightness signal SAc, and the analog-to-digital converter 215 converts the analog ambient color and brightness signal SAc into a digital color and brightness signal SDAc. The memory unit 230 is provided for storing a first lookup table 235 and a second lookup table 236. The first lookup table 235 provides a lookup table of a plurality of brightness expression rates and a plurality of backlight brightness adjustment parameters corresponding to the component of the brightness value of different digital digital color and brightness signals SDAc. The second lookup table 236 provides a lookup table of a plurality of gamma adjustment parameters corresponding to the ambient light of different digital color and brightness signal SDAc. The image processing module 220 receives the digital color and brightness signal SDAc and an image input signal 201, and the image processing module 220 has image format conversion function for converting the image input signal 201 into an image output signal 202, and the image output signal 202 can be displayed on the display module 245.

The image processing module 220 has backlight brightness control function and gamma adjustment functions. From a first lookup table 235, a digital backlight brightness adjustment parameter Sdb is obtained based on the component of the brightness value of the digital color and brightness signal SDAc and the brightness expression rate required by the image input signal 201. The image processing module 220 then executes a signal process to produce the digital backlight adjustment parameter Sdb based on the component of the brightness value of the digital color and brightness signal SDAc and the brightness expression rate of the image input signal 201 together with the data in the first lookup table 235, and the digital-to-analog converter 225 converts the digital backlight brightness adjustment parameter Sdb into an analog backlight adjustment parameter Sb, and the backlight module 240 adjusts the backlight brightness based on the analog backlight adjustment parameter Sb. In addition, the image processing module 220 can execute a signal process to produce the ambient color temperature index values based on the component of the color value of the digital color and brightness signal SDAc. The image processing module 220 obtains gamma adjustment parameters from the second lookup table 236, based on the ambient color temperature index value and generates the gamma expression rate required by the image output signal 202. The image processing module 220 then adjusts the gamma correction expression rate of the image input signal 201 to generate the image output signal 202 based on the digital gamma adjustment parameter.

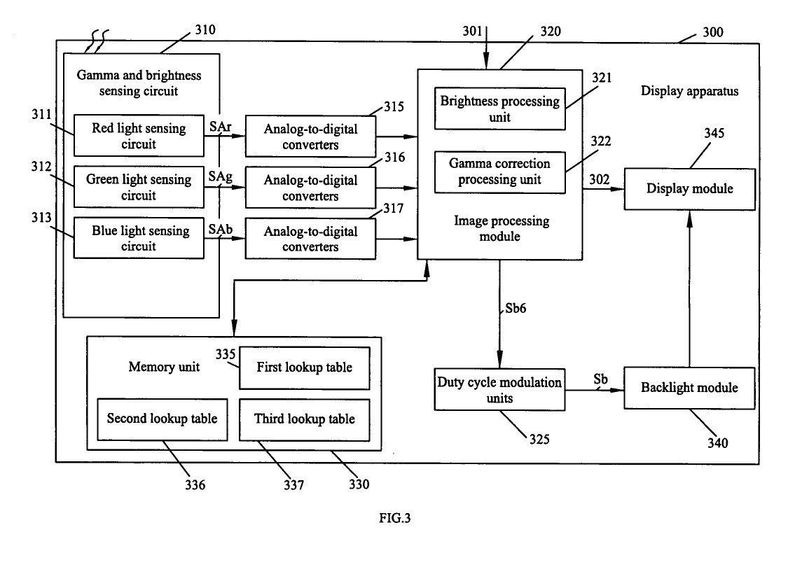

Please referring to FIG. 3 for a schematic block diagram of a display apparatus having color and brightness detection functions in accordance with a second embodiment of the present invention, the display apparatus 300 comprises a color and brightness sensing circuit 310, a plurality of analog-to-digital converters 315, 316 and 317, an image processing module 320, a digital-to-analog converter 325, a memory unit 330, a backlight module 340 and a display module 345.

The color and brightness sensing circuit 310 comprises a red light sensing circuit 311, a green light sensing circuit 312 and a blue light sensing circuit 313. The red light sensing circuit 311 is provided for sensing a red light brightness of an ambient light to generate a red light brightness signal SAr, and the green light sensing circuit 312 senses a green light brightness of an ambient light to generate a green light brightness signal SAg, and a blue light sensing circuit 313 is provided for sensing a blue light brightness of an ambient light to generate a blue light brightness signal SAb. The analog-to-digital converter 315 converts an analog red light brightness signal SAr into a digital red light brightness signal SDAr, and the analog-to-digital converter 316 converts a green light brightness signal Sag into a digital green light brightness signal SDAg, and the analog-to-digital converter 317 converts an analog blue light brightness signal SAb into a digital blue light brightness signal SDAb.

The image processing module 320 receives the digital red light brightness signal SDAr, the digital green light brightness signal SDAg, the digital blue light brightness signal SDAb and an image input signal 301. The image processing module 320 has image format conversion function for converting the image input signal 301 into an image output signal 302, so that the image output signal 302 can be displayed on the display module 345. The image processing module 320 comprises a brightness processing unit 321 and a gamma processing unit 322, and the brightness processing unit 321 executes a numeric operation of the digital red light brightness signal SDAr, the digital green light brightness signal SDAg and the digital blue light brightness signal SDAb to produce a digital brightness value, and the gamma processing unit 322 executes a numeric operation of the digital red light brightness signal SDAr, the digital green light brightness signal SDAg and the digital blue light brightness signal SDAb to produce a digital color temperature index value.

The memory unit 330 is provided for storing a first lookup table 335, a second lookup table 336 and a third lookup table 337. The first lookup table 335 provides a lookup table of a plurality of brightness expression rates and a plurality of backlight brightness adjustment parameters corresponding to different digital brightness values. The second lookup table 336 provides a lookup table of a plurality of gamma correction adjustment parameters corresponding to different digital color temperature index values. The third lookup table 337 provides a lookup table of a plurality of contrast expression rates and a plurality of contrast adjustment parameters corresponding to different digital brightness values.

The image processing module 320 has backlight brightness control function, gamma adjustment function and contrast adjustment function, such that a digital backlight brightness adjustment parameter Sdb can be obtained from the first lookup table 335 based on the digital brightness value and the brightness expression rate required by the image input signal 301, wherein the image processing module 320 executes a signal process to produce the digital backlight brightness adjustment parameter Sdb based on the digital brightness value and the brightness expression rate required by the image input signal 301 together with the data of the first lookup table 335, and the digital-to-analog converter 325 converts the digital backlight adjustment parameter Sdb into an analog backlight adjustment parameter Sb, and the backlight module 340 adjusts a backlight brightness based on the analog backlight adjustment parameter Sb.

Further, the image processing module 320 uses the second lookup table 336 to obtain a digital gamma correction adjustment parameter based on the digital ambient color temperature index value. The image processing module 320 executes a signal process to produce the digital gamma correction express rate based on the digital gamma correction adjustment parameter required by the image input signal 301 together with the data of the second lookup table 336, and the image processing module 320 adjusts the gamma correction expression rate of the image input signal 301 to generate the image output signal 302. For example, in a preferred embodiment of the signal process, the following formula is used for calculating the digital gamma correction adjustment parameter:

CCT_{ambient}=(SDAr−param_{—}1×SDAb)/SDAg

where CCT_{ambient} is the estimated Ambient Color temperature index of the ambient light.

Digital gamma correction adjustment parameter=param_{—}2+param_{—}3×CCT_{ambient} Preferably, the param_{—}2 is an offset parameter, and the param_{—}3 is a gain parameter. The param_{—}1, param_{—}2 and param_{—}3 can be stored second lookup table 336.

In addition, the image processing module 320 uses the third lookup table 337 to obtain a digital contrast adjustment parameter based on the digital brightness value and the contrast expression rate required by the image input signal 301. The image processing module 320 then executes a signal process to produce the digital contrast adjustment parameter based on the digital brightness value and the contrast expression rate required by the image input signal 301 together with the data of the third lookup table 337, and the image processing module 320 adjusts the contrast expression rate of the image input signal 301 to generate the image output signal 302 based on the digital contrast adjustment parameter.

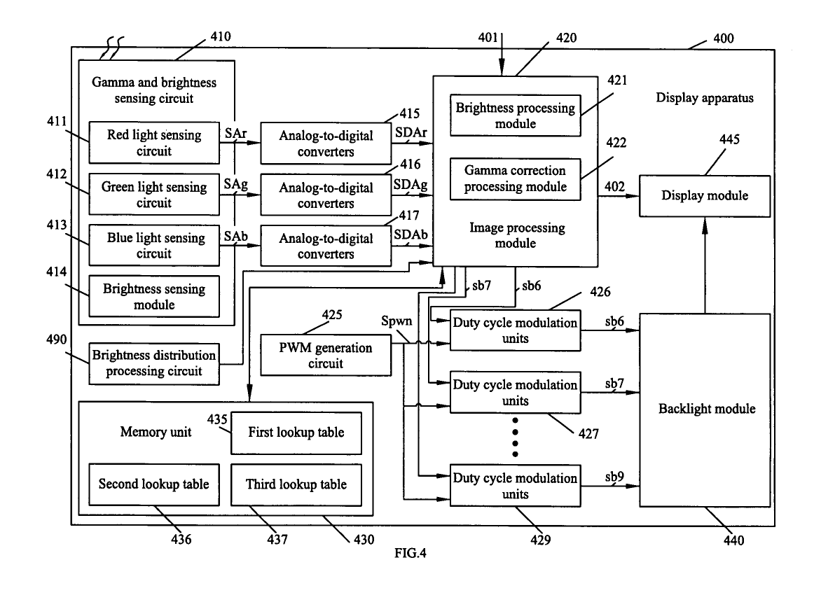

Please referring to FIG. 4 for a schematic block diagram of a display apparatus having gamma and brightness detection functions in accordance with a third embodiment of the present invention, the display apparatus 400 comprises a color and brightness sensing circuit 410, a plurality of analog-to-digital converters 415, 416 and 417, an image processing module 420, a pulse width modulation (PWM) generation circuit 425, a memory unit 430, a backlight module 440, a display module 445, a brightness distribution processing circuit 490 and a plurality of duty cycle modulation units 426, 427, 428, 429. The pulse width modulation generation circuit 425 produces a pulse width modulation signal Spwm to be inputted to the plurality of duty cycle modulation units 426, 427, 428, 429.

The color and brightness sensing circuit 410 comprises a red light sensing circuit 411, a green light sensing circuit 412, a blue light sensing circuit 413 and a radiometric reference sensing module 414. The red light sensing circuit 411 is provided for sensing a red light brightness of an ambient light to generate a red light brightness signal SAr, and the green light sensing circuit 412 is provided for sensing a green light brightness of an ambient light to generate a green light brightness signal SAg, and the blue light sensing circuit 413 is provided for sensing a blue light brightness of an ambient light to generate a blue light brightness signal SAb. The radiometric reference sensing module 414 is provided for sensing the radiometric reference of the display module 445 at different positions and different directions to generate a plurality of signals. The brightness distribution processing circuit 490 generates a digital distribution signal SDD based on the brightness signals, and the digital distribution signal SDD is used for displaying the uneven ambient light distribution situation of an ambient light on the display module 445. For example, if the digital distribution signal SDD is a 4-bit digital signal, then 0000 represents an even distribution situation, and 0001 represents a distribution of an ambient light concentrated at the upper left corner, 0010 represents a distribution of an ambient light concentrated at the upper right corner, 0100 represents a distribution of an ambient light concentrated at the lower left corner, and 1000 represents a distribution of an ambient light concentrated at the lower right corner, and so forth.

The analog-to-digital converter 415 converts the analog red light brightness signal SAr into a digital red light brightness signal SDAr, and the analog-to-digital converter 416 converts a green light brightness signal SAg into a digital green light brightness signal SDAg, and the analog-to-digital converter 417 converts an analog blue light brightness signal SAb into a digital blue light brightness signal SDAb.

The image processing module 420 receives the digital red light brightness signal SDAr, the digital green light brightness signal SDAg, the digital blue light brightness signal SDAb, the digital distribution signal SDD and an image input signal 401. The image processing module 420 has image format conversion function for converting the image input signal 401 into an image output signal 402, so that the image output signal 402 can be displayed on the display module 445. The image processing module 420 comprises a brightness processing unit 421 and a gamma correction processing unit 422, and the brightness processing unit 421 executes a numeric operation of the digital red light brightness signal SDAr, the digital green light brightness signal SDAg and the digital blue light brightness signal SDAb to produce a digital brightness value, and the gamma correction processing unit 422 executes a numeric operation of the digital red light brightness signal SDAr, the digital green light brightness signal SDAg and the digital blue light brightness signal SDAb to produce a digital color temperature index value.

The memory unit 430 is provided for storing a first lookup table 435, a second lookup table 436 and a third lookup table 437. The first lookup table 435 provides a lookup table of a plurality of brightness expression rates and a plurality of backlight adjustment parameters corresponding to different digital brightness values. The second lookup table 436 provides a lookup table of a plurality of gamma correction adjustment parameters corresponding to different digital color temperature index values. The third lookup table 437 provides a lookup table of a plurality of contrast expression rates and a plurality of contrast adjustment parameters corresponding to different digital brightness values.

The image processing module 420 has backlight brightness distribution control function, the gamma adjustment function and contrast adjustment function, and uses the first lookup table 435 to obtain an original digital backlight brightness adjustment parameter based on the digital brightness value and the brightness expression rate required by the image output signal 402, and the image processing module 420 produce a plurality of digital backlight adjustment parameters Sdb6, Sdb7, Sdb8, Sdb9 based on the original digital backlight adjustment parameter together with the digital distribution signal SDD. The plurality of digital backlight brightness adjustment parameter Sdb6, Sdb7, Sdb8, Sdb9 are inputted to a plurality of duty cycle modulation units 426, 427, 428 429 respectively. The plurality of duty cycle modulation units 426, 427, 428, 429 are used to adjust the duty cycle of the pulse width modulation signal Spwm to generate a plurality of backlight brightness driving signals Sb6, Sb7, Sb8, Sb9 based on the plurality of digital backlight adjustment parameters Sdb6, Sdb7, Sdb8, Sdb9 respectively. The plurality of backlight brightness driving signals Sb6, Sb7, Sb8, Sb9 are used to drive the backlight module 440 to produce the required backlight brightness distribution.

Further, the image processing module 420 uses the second lookup table 436 to obtain a digital gamma correction adjustment parameter based on the digital color temperature index value and generates the gamma correction expression rate required by the image input signal 401, and the image processing module 420 adjusts the gamma correction expression rate of the image input signal 401 to generate the image output signal 402 based on the digital gamma correction adjustment parameter. In addition, the image processing module 420 uses the third lookup table 437 to obtain a digital contrast adjustment parameter based on the digital brightness value and the contrast expression rate required by the image input signal 401, and the image processing module 420 adjusts the contrast expression rate of the image input signal 401 to generate the image output signal 402 based on the digital contrast adjustment parameter.

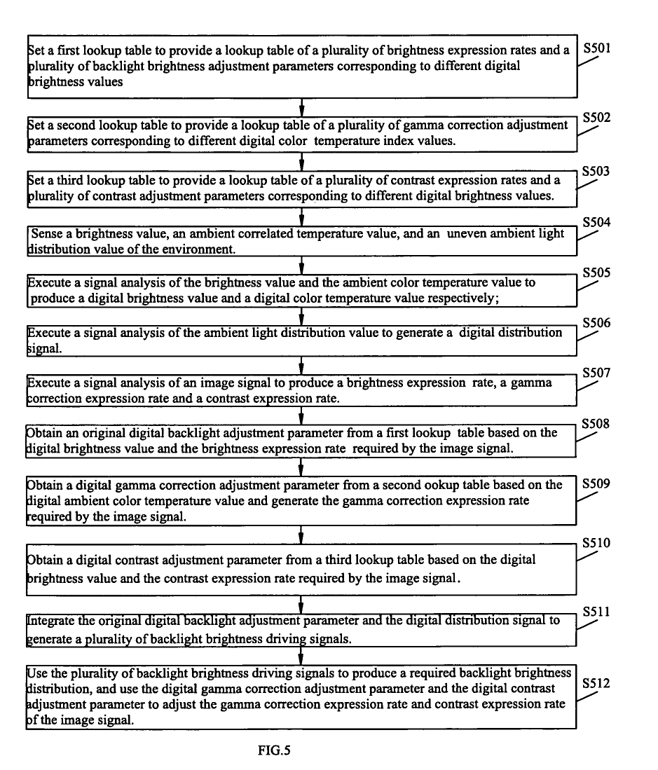

Referring to FIG. 5 for a flow chart of a gamma and brightness adjustment method used in a display apparatus in accordance with the present invention, the gamma and brightness adjustment method adjusts the backlight brightness and distribution, the gamma correction expression rate of an image, and the contrast expression rate of an image of the display apparatus to display an image signal based on the brightness, ambient correlated color temperature, and uneven ambient light distribution information of an environment, and the gamma and brightness adjustment method comprises the following steps:

Step S501: Set a first lookup table to provide a lookup table of a plurality of brightness expression rates and a plurality of backlight brightness adjustment parameters corresponding to different digital brightness values.

Step S502: Set a second lookup table to provide a lookup table of a plurality of gamma correction adjustment parameters corresponding to different digital color temperature index values.

Step S503: Set a third lookup table to provide a lookup table of a plurality of contrast expression rates and a plurality of contrast adjustment parameters corresponding to different digital brightness values.

Step S504: Sense a brightness value, an ambient correlated temperature value, and an uneven ambient light distribution value of the environment.

Step S505: Execute a signal analysis of the brightness value and the ambient color temperature value to produce a digital brightness value and a digital color temperature value respectively;

Step S506: Execute a signal analysis of the ambient light distribution value to generate a digital distribution signal.

Step S507: Execute a signal analysis of an image signal to produce a brightness expression rate, a gamma correction expression rate and a contrast expression rate.

Step S508: Obtain an original digital backlight adjustment parameter from a first lookup table based on the digital brightness value and the brightness expression rate required by the image signal.

Step S509: Obtain a digital gamma correction adjustment parameter from a second lookup table based on the digital ambient color temperature value and generate the gamma correction expression rate required by the image signal.

Step S510: Obtain a digital contrast adjustment parameter from a third lookup table based on the digital brightness value and the contrast expression rate required by the image signal.

Step S511: Integrate the original digital backlight adjustment parameter and the digital distribution signal to generate a plurality of backlight brightness driving signals.

Step S512: Use the plurality of backlight brightness driving signals to produce a required backlight brightness distribution, and use the digital gamma correction adjustment parameter and the digital contrast adjustment parameter to adjust the gamma correction expression rate and contrast expression rate of the image signal. In Step S508, an original digital backlight adjustment parameter obtained from a first lookup table based on the digital brightness value and the brightness expression rate of the image signal can be generated from the digital brightness value and the brightness expression rate of an image signal together with the data of the first lookup table to execute a signal process to produce the original digital backlight adjustment parameter. In Step S509, a digital gamma correction adjustment parameter obtained from a second lookup table based on the digital color temperature index value and generates the gamma correction expression rate of an image signal. In Step S510, a digital contrast adjustment parameter obtained from a third lookup table based on the digital brightness value and the contrast expression rate of an image signal can be generated from the digital brightness value and the contrast expression rate of the image signal together with the data of the third lookup table to execute a signal process to produce the digital contrast adjustment parameter.

In summation of the description above, when the display apparatus having color and brightness detection functions in accordance with the present invention executes display function, the backlight brightness and distribution, and the gamma correction expression rate and the contrast expression rate of an image can be used to adjust the display apparatus based on the brightness, ambient correlated color temperature and uneven ambient light distribution in order to provide a display with vivid video or digital image for viewing.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display apparatus of adjusting gamma and brightness based on an ambient light, for receiving and displaying an image input signal, and the display apparatus comprising:
a plurality of light sensing circuits for sensing at least two color light brightness of the ambient light to generate a plurality of light brightness signals respectively;
a memory unit for storing a lookup table, and the lookup table providing a plurality of gamma coefficient and a plurality of gamma adjustment parameters corresponding to different ambient light correlated temperature conditions;
an image processing module for receiving the image input signal from any image sources, and coupled to the light sensing circuits to receive the light brightness signals respectively, and executes a numeric operation of the light brightness signals to generate an ambient color temperature index value, and the image processing module being coupled to the memory unit to process the image input signal by using the lookup table, and the image processing module obtaining a gamma correction adjustment parameter by using the lookup table based on the ambient color temperature index value and generating the gamma correction expression rate of the image input signal, and the image processing module adjusting a gamma correction expression rate of the image input signal based on the gamma correction adjustment parameter to generate an image output signal; and
a display module coupled to the image processing module, and for displaying the image output signal.

2. The display apparatus of claim 1, wherein the plurality of light sensing circuits include a red light sensing circuit, a green light sensing circuit and a blue light sensing circuit, and the red light sensing circuit is used for sensing a red light brightness of the ambient light to generate a red light brightness signal, and the green light sensing circuit is used for sensing a green light brightness of the ambient light to generate a green light brightness signal, and the blue light sensing circuit is used for sensing a blue light brightness of the ambient light to generate a blue light brightness signal.

3. The display apparatus of claim 1, further comprising a backlight module coupled to the image processing module to provide a backlight brightness required by the display module.

4. The display apparatus of claim 3, wherein the image processing module comprises:
a gamma processing unit for executing numeric calculations of the red light brightness signal, the green light brightness signal and the blue light brightness signal to produce the ambient color temperature index value; and
a brightness processing unit for executing numeric calculations of the red light brightness signal, the green light brightness signal and the blue light brightness signal to produce the brightness value.

5. The display apparatus of claim 4, wherein the memory unit stores a first lookup table, and the first lookup table provides a plurality of brightness expression rates and a plurality of backlight brightness adjustment parameters corresponding to different brightness values, and each backlight adjustment parameters corresponds to one of the brightness expression rates.

6. The display apparatus of claim 1, wherein the image processing module obtains a gamma correction adjustment parameter by using a second lookup table based on the ambient color temperature index value and generate the gamma expression rate of the image input signal, and the image processing module adjusts a gamma correction expression rate of the image input signal based on the gamma correction adjustment parameter.

7. The display apparatus of claim 2, wherein the blue light brightness signal is multiplied with a first parameter to generate a first multiplied result, and then the multiplied result is subtracted by the red light brightness signal, and the subtracted result is divided by the green light brightness signal to generate the ambient color temperature index value.

8. The display apparatus of claim 4, wherein the ambient color temperature index value is multiplied with a gain parameter to generate a second multiplied result, and the second multiplied result is added by an offset parameter to generate the gamma correction adjustment parameter.

9. The display apparatus of claim 5, wherein the memory unit stores a third lookup table, and the third lookup table provides a lookup table of a plurality of contrast expression rates and a plurality of contrast adjustment parameters corresponding to different brightness values, and each contrast adjustment parameters corresponds to one of the contrast expression rates.

10. The display apparatus of claim 1, wherein the image processing module further provides a contrast adjustment parameter by using the third lookup table based on the brightness value and the contrast expression rate of the image input signal, and the image processing module adjusts the contrast expression rate of the image input signal based on the contrast adjustment parameter to generate the image output signal.

11. The display apparatus of claim 1, further comprising:
a brightness sensing module for sensing a brightness of the display module at different positions or different directions to generate a plurality of brightness signals;
a brightness distribution processing circuit coupled to the brightness sensing module, and for generating a distribution signal based on the brightness signal;
a backlight module for providing a backlight brightness required by the display module;
a pulse width modulation (PWM) generation circuit for generating a pulse width modulation signal; and
a plurality of duty cycle modulation units separately coupled to the pulse width modulation generation circuit to receive the pulse width modulation signal.

12. The display apparatus of claim 11, wherein the image processing module obtains an original backlight adjustment parameter by using the second lookup table based on the brightness value and the brightness expression rate of the image input signal, and the image processing module produces a plurality of backlight adjustment parameters based on the original backlight adjustment parameter together with the distribution signal, and the backlight adjustment parameters are inputted separately to the duty cycle modulation units, and the duty cycle modulation units separately adjust the duty cycle of the pulse width modulation signal to generate a plurality of backlight brightness driving signals based on the backlight adjustment parameters, and the backlight brightness driving signals are used for driving the backlight module to produce a required backlight brightness distribution.

13. A gamma and brightness adjustment method applied in a display apparatus, and the gamma and brightness adjustment method comprising:
setting a second lookup table to provide a lookup table of a plurality of gamma correction adjustment parameters corresponding to different digital color temperature index values;
sensing an ambient correlated temperature value of the ambient light;
executing a signal analysis of the image input signal to produce a gamma correction expression rate;
obtaining a gamma correction adjustment parameter from the second lookup table based on the ambient color temperature index value and generates the gamma correction expression rate required by the image input signal; and
using the gamma correction adjustment parameter to adjust the gamma correction expression rate of the image input signal to generate the image output signal.

14. The gamma and brightness adjustment method of claim 13, wherein the gamma correction adjustment parameter obtained from the second lookup table based on the ambient color temperature index value and the desired displaying gamma correction expression rate of the image input signal is generated from the gamma correction value and the gamma correction expression rate of the image input signal together with the data of the second lookup table to execute a signal process to produce the gamma correction adjustment parameter.

15. The gamma and brightness adjustment method of claim 13, further comprising:
setting a first lookup table to provide a lookup table of a plurality of brightness expression rates and a plurality of backlight brightness adjustment parameters corresponding to different brightness values;
sensing a brightness value of the ambient light;
executing a signal analysis of the image input signal to produce a brightness expression rate;
obtaining a backlight adjustment parameter from the first lookup table based on the brightness value and the brightness expression rate of the image input signal; and
using the backlight adjustment parameter to adjust a backlight brightness of the display apparatus.

16. The gamma and brightness adjustment method of claim 13, further comprising:
setting a third lookup table to provide a lookup table of a plurality of contrast expression rates and a plurality of contrast adjustment parameters corresponding to different brightness values;
sensing a brightness value of the ambient light;
executing a signal analysis of the image input signal to generate a contrast expression rate;
obtaining a contrast adjustment parameter from the third lookup table based on the color temperature index value and the contrast expression rate of the image input signal; and
using the contrast adjustment parameter to adjust a contrast expression rate of the image input signal to generate the image output signal.

17. The gamma and brightness adjustment method of claim 13, further comprising:
setting a first lookup table for providing a lookup table of a plurality of brightness expression rates and a plurality of backlight adjustment parameters corresponding to different brightness values;
sensing a brightness value and an ambient light distribution value of the ambient light;
executing a signal analysis of the ambient light distribution value to generate a distribution signal;
executing a signal analysis of the image input signal to produce a brightness expression rate;
obtaining an original backlight adjustment parameter from the first lookup table based on the brightness value and the brightness expression rate;
integrating the original backlight adjustment parameter and the digital distribution signal to generate a plurality of backlight brightness driving signals; and
using the backlight brightness driving signals to produce a desired backlight brightness distribution.
